(19) United States
(12) Patent Application Publication
(10) Pub. No.: US 2007/0162901 A1
(43) Pub. Date: Jul. 12, 2007

(54) Operating system switching device and operating system switching method

(75) Inventor: Yoon-hwan Oh, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/646,446

(22) Filed: Dec. 28, 2006

(30) Foreign Application Priority Data
Jan. 12, 2006 (KR) 2006-3609

(51) Int. Cl. G06F 9/45; G06F 9/44

(52) U.S. Cl. 717/148; 717/118

(57) ABSTRACT

An operating system switching device includes an input unit which supplies a selection signal corresponding to one or more operating systems selected from a plurality of operating systems, and a virtual machine creating unit which creates one or more virtual machines that correspond to the selected operating systems and boots the corresponding selected operating systems. The virtual machine creating unit includes an extensible firmware interface.

### CROSS-REFERENCE TO RELATED APPLICATIONS

This application claims the benefit of Korean Application No. 2006-3609, filed Jan. 12, 2006, in the Korean Intellectual Property Office, the disclosure of which is incorporated herein by reference.

### BACKGROUND OF THE INVENTION

1. Field of the Invention

Aspects of the present invention relate to a computer device and method, and more particularly, to an operating system switching device and an operating system switching method in which a virtual machine, independent of an operating system, is supplied.

2. Description of the Related Art

An operating system (OS) is a set of programs that provides interfaces which enable a user to easily use hardware within a computer, such as a personal computer (PC). The OS manages a processor, a storage device, an input/output device, a communication device, data, and many other components which function with a computer.

IBM developed the world's original operating system, the IBM system/360, and thereafter, Microsoft developed MS-DOS, Windows 3.1, Windows 95, and Windows 98 as operating systems to be used in PCs, along with the most current operating system, Windows XP. Meanwhile, Windows NT, Windows 2000, UNIX, Solaris and LINUX (a modified version of the UNIX operating system) have been widely used in workstations and server computer devices which have high-performance microprocessors.

Occasionally, a user installs a plurality of operating systems into one recording medium to use each operating system for a specific purpose or need. For example, a user might respectively install Windows XP and LINUX into two logically divided regions of one recording medium, install application programs supported by each of the corresponding operating systems so that the computer device can be booted by a desired operating system, and perform requested tasks on the corresponding operating system.

The term “multi-booting” refers to installing a plurality of operating systems in such a way that a user can select among the different operating systems. In traditional multi-booting configurations, a user encountered the problem that he or she needed to reboot the computer having the plurality of installed operating systems each time he or she wanted to switch use from one operating system to another operating system.

In order to solve the above-described problem, the related art employed a virtualization technology which allows different kinds of operating systems to be used within a predetermined operating system. More specifically, in the virtualization technology of the related art, a virtualization layer is formed on a host operating system, and a plurality of logical virtual machines are created on the virtualization layer. Each one of the virtual machines in the plurality of virtual machines generally includes a guest operating system. Additionally, the virtualization technology generally requires the installation of various application programs, supported by each of the corresponding operating systems, onto the corresponding operating system. In a computer device which includes the virtualization layer, the host operating system and the plurality of guest operating systems are switched through the virtualization layer.

However, the conventional virtualization technology is dependent on a host operating system. In other words, when a user forms the virtualization layer onto the host operating system, the virtualization layer according to the conventional virtualization technology must be formed in consideration of the type of host operating system hosting the virtualization technology. This conventional virtualization technology is not efficient.

### SUMMARY OF THE INVENTION

An aspect of the present invention provides an operating system switching device which provides a virtual machine independent of an operating system, and method of using an operating system switching device which provides a virtual machine independent of an operating system.

Additional aspects and/or advantages of the invention will be set forth in part in the description which follows and, in part, will be obvious from the description, or may be learned by practice of the invention.

Aspects of the present invention are not limited to the aspects mentioned above, and other aspects of the present invention will be apparently understood by those skilled in the art through the following description. In order to achieve the above and/or other aspects and/or other advantages, according to an aspect of the present invention, an operating system switching device includes an input unit which receives a selection signal corresponding to one or more operating systems among a plurality of operating systems, and a virtual machine creating unit which creates one virtual machine corresponding to each of the selected operating systems to boot the selected operating systems.

The virtual machine creating unit preferably, but not necessarily, includes firmware.

Furthermore, according to another aspect of the present invention, an operating system switching method includes selecting one or more operating systems among a plurality of operating systems, and creating one or more virtual machines which correspond to the selected operating systems to boot the corresponding operating systems. The virtual machine is created by a virtual machine creating unit which preferably includes firmware.

### BRIEF DESCRIPTION OF THE DRAWINGS

These and/or other aspects and advantages of the present invention will become more apparent and more readily appreciated from the following description of the embodiments, taken in conjunction with the accompanying drawings of which:

FIG. 1 is a block diagram showing the configuration of an operating system switching device according to an embodiment of the present invention;

FIGS. 2A to 2C are block diagrams showing a user interface to select an operating system according to the embodiment of the present invention;

FIGS. 3A to 3C are block diagrams showing a user interface to select an operating system according to another embodiment of the present invention; and

FIG. 4 is a flowchart showing an operation process of an operating system switching device according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention will be described hereinafter with reference to block diagrams or flowchart illustrations of an operating system switching device and method thereof according to an embodiment thereof. It is understood that each block of the flowchart illustrations and combinations of blocks in the flowchart illustrations may be implemented by computer program instructions. These computer program instructions may be provided to a processor of a general purpose computer, special purpose computer, or other programmable data processing apparatus in order to produce a machine, such that the instructions, which execute via the processor of the computer or other programmable data processing apparatus, may be used to implement the functions specified in the flowchart block or blocks. These computer program instructions may also be stored in a computer usable or computer-readable memory, which may direct a computer or other programmable data processing apparatus to function in a particular manner, such that the instructions stored in the computer usable or computer-readable memory produce an article of manufacture, including, but not limited to, instructions which implement a function specified in the flowchart block or blocks. The computer program instructions may also be loaded onto a computer or other programmable data processing apparatus to perform series of operations on the computer or other programmable apparatus in order to produce a computer implemented process, so that the instructions which are executed on the computer or other programmable apparatus provide operations for implementing the functions specified in the flowchart block or blocks.

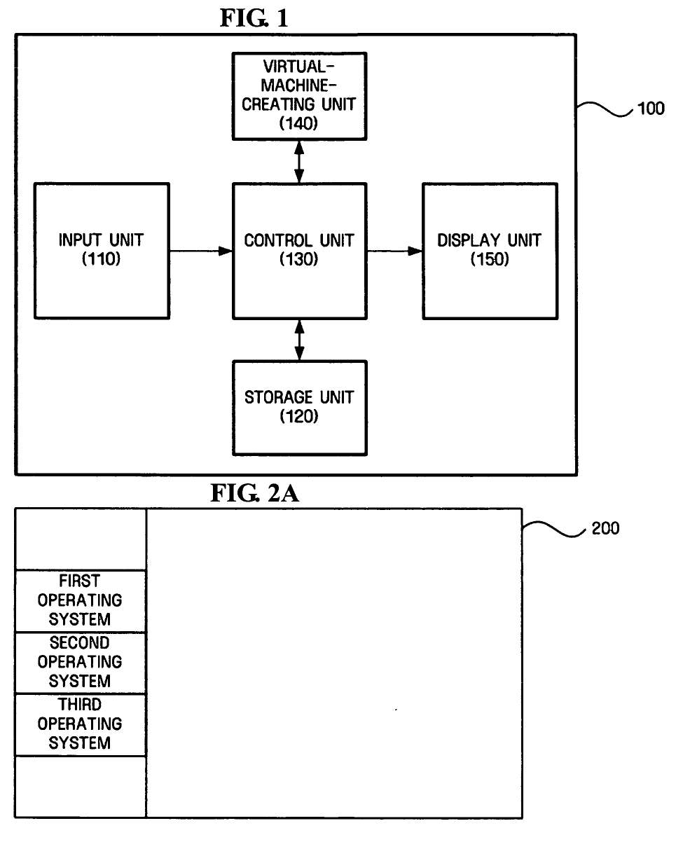

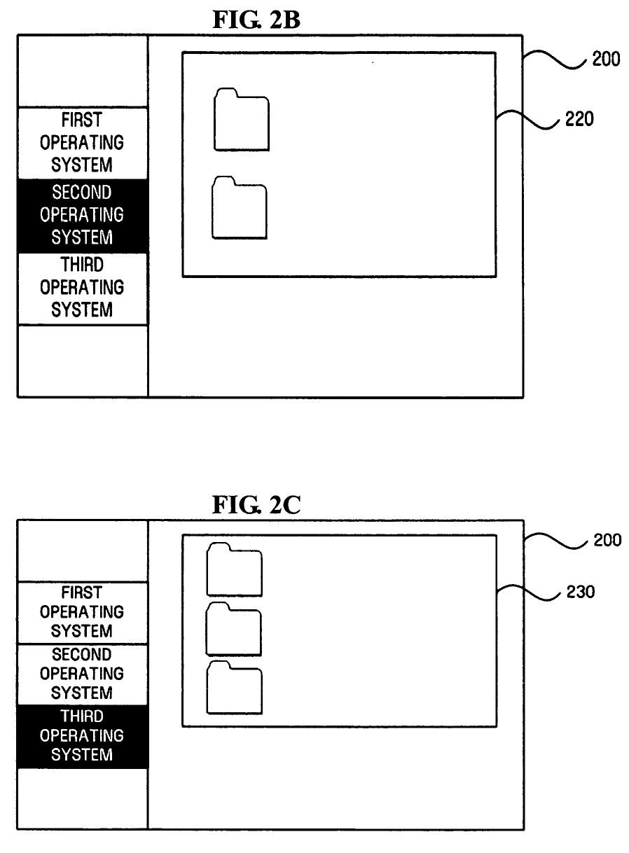

Furthermore, each block of the block diagrams illustrated in FIGS. 1, 2A-C, 3A-C, and 4, may represent a module, segment, or portion of code which comprises one or more executable instructions for implementing a specified logical function. It should also be noted that in some alternative implementations, the functions noted in the blocks may occur out of order. For example, two blocks illustrated in succession may in fact be executed simultaneously or nearly simultaneously. The blocks may also be executed out of order and/or in the reverse order of the order illustrated in the block diagrams, depending upon which function a user is executing.

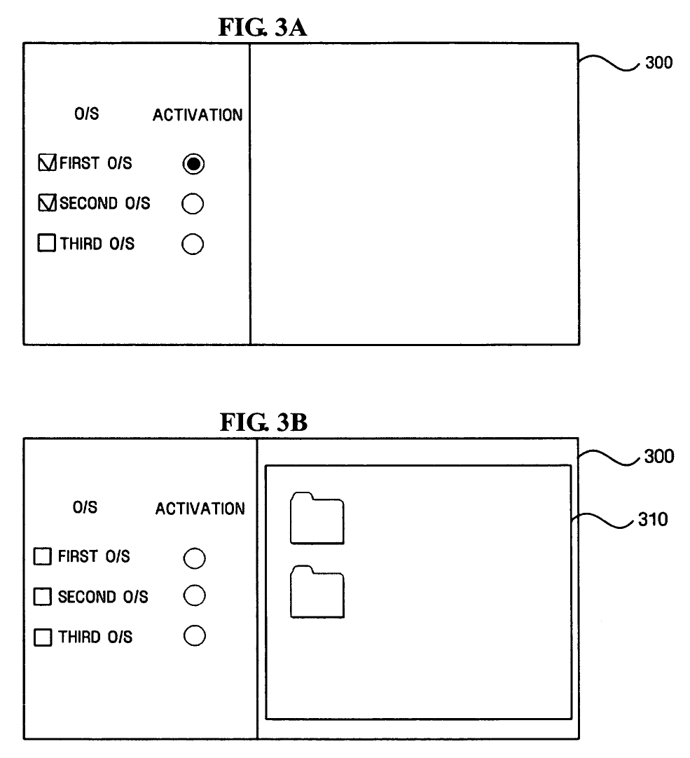

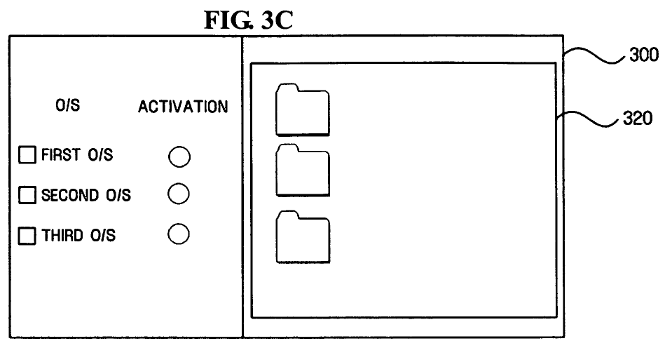

First, an operating system switching device according to embodiments of the present invention will be described with reference to FIGS. 1 to 3C. FIG. 1 is a block diagram which illustrates the configuration of an operating system switching device according to an embodiment of the present invention. FIGS. 2A to 2C are block diagrams which illustrate a user interface to select an operating system according to an embodiment of the present invention. FIGS. 3A to 3C are block diagrams which illustrate a user interface to select an operating system according to another embodiment of the present invention.

An operating system switching device 100 according to an embodiment of the present invention is preferably, although not necessarily, constructed as a digital device. The term “digital device” generally refers to a device having a digital circuit to process digital data. Examples of digital devices include a computer, a printer, a digital camera, a facsimile machine, a digital copy machine, a digital home electronic appliance, a digital phone, a digital projector, a home server, a digital video recorder, a set top box, a PDA (Personal Digital Assistant), and a cellular phone. It is understood there are numerous other digitals devices not listed herein.

More specifically, the operating system switching device 100 illustrated in FIG. 1 includes at least an input unit 110, a storage unit 120, a virtual machine creating unit 140, a control unit 130, and a display unit 150. It is understood that other components may also be used with the operating system switching device 100.

The input unit 110 allows a user to input an operating system selection signal, an operating system switching signal, an operating system activation signal, and numerous other types of signals into the operating system switching device 100. The input unit 110 can be a separately formed hardware component, such as, for example, a keyboard, a keypad, and/or a mouse, formed independently from the display unit 150, which will be described later. Or, the input unit 110 can be formed as part of the display unit 150, such as, for example, a touch screen. It is understood that the input unit 110 is not limited to being either a separately formed component of the display unit 150 or an integrally formed component of the display unit 150, and may instead be a combination of the two, such as, for example, a keyboard and touch screen combination input unit 110.

In an example where the input unit 110 is a keyboard, the input unit 110 may include a plurality of function keys (not illustrated), such as a power key which supplies power to the operating system switching device 100, a selection key which switches a desired operating system among a plurality of operating systems, a switching key which switches an operating system, an activation key which activates a certain operating system among a plurality of operating systems, and an execution key which executes a user command. It is understood that the keyboard input unit 110 may include many other types of keys.

In an example where the input unit 110 is integrally formed with the display unit 150 (which will be described later), an execution key which executes a user command, a switching key which switches an operating system, and an activation key which activates a certain operating system may be implemented as software stored in the operation system switching device 100.

The storage unit 120 stores commands, programs, and a plurality of operating systems, all of which are necessary to operate the operating system switching device 100 according to an embodiment of the present invention. The storage unit 120 may be any one of, but is not limited to, a nonvolatile memory device such as a cache, a ROM (Read Only Memory), a PROM (Programmable ROM), an EPROM (Erasable Programmable ROM), an EEPROM (Electrically Erasable Programmable ROM), a flash memory, a volatile memory device such as a RAM (Random Access Memory), or a storage medium, such as a hard disk drive (HDD) or a CD-ROM. When the storage unit 120 is implemented by a storage medium such as a hard disk drive, the storage unit 120 may be divided into logical regions corresponding to the plurality of operating systems. The plurality of operating systems may then be stored in these divided logical regions of the storage unit 120. Alternatively, the plurality of operating systems may all be stored in one region among the divided plurality of logical regions.

The virtual machine creating unit 140 provides information to a user corresponding to the operating systems stored in the storage unit 120. For example, the virtual machine creating unit 140 provides a user interface which allows a user to select the desired operating system by selecting an icon with the name of the operating system, e.g., Windows XP. For example, when the storage unit 120 includes a first, second, and third operating system, the machine creating unit 140 provides a user interface 200 to select the operating system as illustrated in FIG. 2A. A user may select a predetermined operating system from the plurality of operating systems by using the user interface 200 to select the operating system. FIG. 2B shows an example where a second operating system is selected among the plurality of operating systems stored in the storage unit 120.

According to another example, the user may select two or more operating systems by the user interface which selects the operating system. In this case, as illustrated in FIG. 3A, the user interface 300 which selects the operating system may include a graphic object, such as a check box, that a user can “check” to select a plurality of operating systems and a different graphic object, such as an option box, that a user can click on to activate an operating system. It is understood that other visual representations may be used instead of a check box and an option box. When a user selects two or more operating systems, the user may activate one of the selected operating systems. The term “activate” refers to selecting an operating system in order to display the operating system through the display unit 150. FIG. 3A illustrates an example where a user selects the first and second operating systems among the plurality of operating systems stored in the storage unit 120, and then activates the first operating system.

After providing information to a user corresponding to the operating systems stored in the storage unit 120, the virtual machine creating unit 140 then creates a virtual machine corresponding to the operating system selected by the user through the user interface. For example, as illustrated in FIG. 2B, when the second operating system is selected, the virtual machine creating unit 140 creates a virtual machine corresponding to the second operating system. When the virtual machine corresponding to the second operating system is created, the second operating system is loaded into a memory unit (not illustrated) in preparation to be booted. Thereafter, the second operating system can access data sources, such as registers, memories, or I/O devices, included in the operating system switching device 100 through the virtual machine created by the virtual machine creating unit 140.

According to another example, when a user selects a plurality of operating systems through the user interface 300 (FIGS. 3A-C), the virtual machine creating unit 140 creates a plurality of virtual machines corresponding to the plurality of operating systems selected by the user. Specifically, as illustrated in FIG. 3A, when the first and second operating systems are selected, the virtual machine creating unit 140 creates a first virtual machine corresponding to the first operating system, and creates a second virtual machine corresponding to the second operating system. In this example, the virtual machines within the plurality of virtual machines operate independently from each other. Specifically, the first operating system accesses sources, such as registers, memories, or I/O devices, included in the operating system switching device 100 through the first virtual machine, and the second operating system accesses sources, such as registers, memories, or I/O devices, included in the operating system switching device 100 through the second virtual machine. The virtual machine supports multiple operating environments (or partitions) where each partition is led to believe it has sole access to the physical hardware. The virtual machine enables multiple operating systems to share hardware and allows applications to run without modifications.

As described above, the virtual machine creating unit 140 preferably, but not necessarily, takes the form of EFI (Extensible Firmware Interface). When the virtual machine creating unit 140 takes the form of firmware, such as EFI, the above-described user interface, which enables a user to select a desired operating system, may be provided in an operation of checking peripheral devices before the operating system switching device 100 is booted by using a predetermined operating system. The checking of peripheral devices before the operating system switching device 100 is booted is preferably, but not necessarily a POST (Power-On Self Test) step.

The control unit 130 connects components, such as the input unit 110, the storage unit 120, the virtual machine creating unit 140, and the display unit 150, included in the operating system switching device 100, as illustrated in FIG. 1. The control unit 130 determines the kind of signals inputted through the input unit 110 by a user, and then controls components included in the operating system switching device 100 based on the determination result of the inputted signal. When a user selects a certain operating system by inputting a selection signal at the user interfaces 200 or 300, the control unit 130 commands the virtual machine creating unit 140 to create a virtual machine corresponding to the selected operating system. For example, as illustrated in FIG. 2B, when a user selects the second operating system, the control unit 130 commands the virtual machine creating unit 140 to create a virtual machine corresponding to the second operating system.

As illustrated in FIG. 3A, if a user inputs a selection signal into the user interface 300 selecting a first or a second operating system, the control unit 130 commands the virtual machine creating unit 140 to create a plurality of virtual machines corresponding to the first and second operating systems, respectively. Then, the control unit 130 commands the display unit 150 to display an interactive window corresponding to the first operating system which the user has activated through the user interface 300.

The display unit 150 visually displays a command processing result. For example, as illustrated in FIG. 2A and 3A, the display unit 150 displays the user interfaces 200 and 300 to select the operating systems provided by the virtual machine creating unit 140. Additionally, the display unit 150 displays an interactive window of the operating system activated by the user selection. The display unit 150 may be, but is not limited to being, an image display unit such as an LCD (Liquid Crystal Display), an LED (Light Emitting Diode), an OLED (Organic Light Emitting Diode), or a PDP (Plasma Display Panel). It is understood that the display unit 150 may be other types of display units as well.

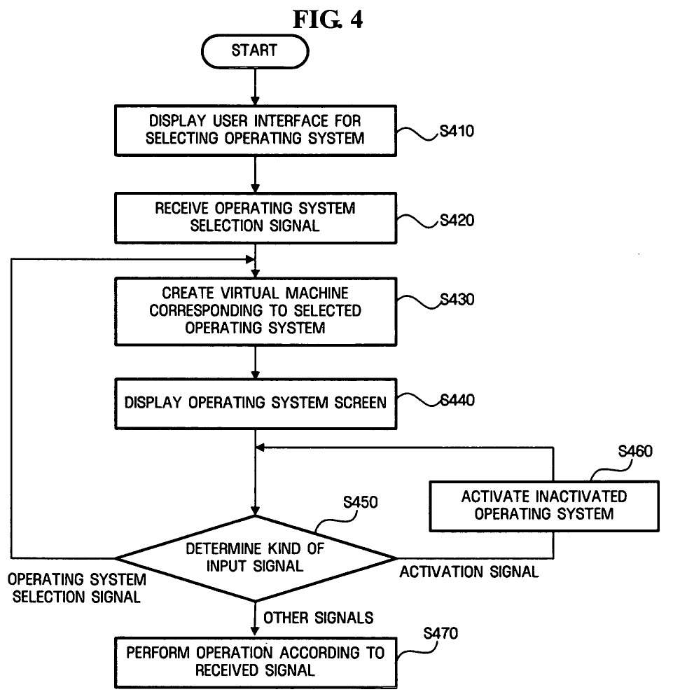

Next, an operating system switching method according to another embodiment of the present invention will be described with reference to FIGS. 2A to 4. FIG. 4 is a flowchart showing an operation process of the operating system switching device 100 according to another embodiment of the present invention.

The following description of the operation process of the operating system switching device 100 assumes that first, second, third, and fourth operating systems are all stored in the operating system switching device 100. It is understood, however, that the present invention is not limited to storing four operating systems, and may store more than four operating systems.

When power is applied to the operating system switching device 100, a process of checking and initiating peripheral devices is performed, such as, for example, the POST process. During the process of checking and initiating peripheral devices, such as, for example, during the POST process, the virtual machine creating unit 140 constructs the user interfaces 200 and 300 which enable the user to select a desired operating system. Each operating system is stored in the storage unit 120. For example, the virtual machine creating unit 140 constructs the user interface 200 which enables a user to select the operating system illustrated in FIG. 2A. The display unit 150 then displays the user interface, which the virtual machine creating unit 140 created and which a user can use to select a desired operating system (S410).

When the user interface is displayed, the user can then select a specific operating system among the plurality of operating systems. When the user interface receives the selection signal selecting a certain operating system inputted from a user (S420), the control unit 130 commands the virtual machine creating unit 140 to create a virtual machine corresponding to the selected operating system (S430). For example, when the second operating system is selected in FIG. 2A, the control unit 130 commands the virtual machine creating unit 140 to create a virtual machine corresponding to the second operating system.

When the virtual machine creating unit 140 creates the virtual machine corresponding to the second operating system as described in the immediately preceding example, the control unit 130 commands the display unit 150 to display an interactive window corresponding to the second operating system, as illustrated in FIG. 2B (S440). When the display unit 150 displays the interactive window corresponding to the second operating system, the user can then use application programs which operate with the second operating system.

As illustrated in FIG. 2B, when a control signal is inputted through the input unit 110 while an interactive window 220 corresponding to the second operating system is displayed, the control unit 130 determines the type of inputted control signal, and then commands the operating system switching device 100 to function according to the determined inputted control signal.

When a selection signal corresponding to another operating system is inputted to the input unit 110 (an operating system selection signal illustrated in FIG. 4), the control unit 130 commands the corresponding virtual machine creating unit 140 to create a virtual machine corresponding to the selected operating system (S450). For example, when a user selects the third operating system illustrated in FIG. 2A, the control unit 130 commands the virtual machine creating unit 140 to create a virtual machine corresponding to the third operating system (S430). After the virtual machine creating unit 140 creates the virtual machine corresponding to the third operating system, the third operating system is loaded into a memory (not illustrated) by the corresponding virtual machine, in preparation to be booted. As a result, as illustrated in FIG. 2C, an interactive window 230 corresponding to the third operating system is displayed through the display unit 150 (S440). At this point, the control unit 130 deactivates the second operating system, and the interactive window 220 corresponding to the second operating system disappears from the display unit 150. It is understood that the interactive window 220 does not have to completely disappear from the display unit 150, and instead may simply be minimized in size or otherwise altered.

As illustrated in FIG. 2C, if a user inputs an activation signal (FIG. 4) to the input unit 110 while the interactive window 230 corresponding to the third operating system is displayed (S450 in FIG. 4), the control unit 130 activates the deactivated operating system, for example, the second operating system (S460). As a result, as illustrated in FIG. 2B, the interactive window 220 corresponding to the second operating system reappears on the display unit 150. Thus, the control unit 130 sequentially activates any one of the deactivated operating systems whenever a user inputs an activation signal to the input unit 110.

On the other hand, when the user interface to select the operating system provided by the virtual machine creating unit 140 is displayed as illustrated in FIG. 3A, an operation process of the operating system switching device 100 is the same as the above-described operating system switching device 100 except for the differences described below.

During the receiving of an operating system selection signal (S420) (FIG. 4), a user may input a selection signal corresponding to a plurality of operating systems, instead of only a single operating system. Additionally, the user may include activation information with the operating system selection signal, which is received when the operating system selection signal is received (S420). For example, as illustrated in FIG. 3B, a selection signal corresponding to the first and second operating systems and information about an operating system to be activated can be received.

When a user inputs a selection signal into the input unit 110 to select a plurality of operating systems (S420), the virtual machine creating unit 140 creates virtual machines respectively corresponding to the plurality of operating systems selected by the user (S430). For example, if the user selects the first and second operating systems, as illustrated in FIG. 3A, the virtual machine creating unit 140 creates virtual machines corresponding to the first and second operating systems.

Thereafter, operating systems corresponding to each of the virtual machines are loaded into the memory (not illustrated) in preparation to be booted. For example, the first and second operating systems are respectively loaded into the memory in preparation to be booted.

Once the plurality of operating systems is booted, the control unit 130 commands the display unit 150 to display an interactive window of the corresponding operating system according to activation information provided through the user interface by a user (S440). For example, when a user selects the first operating system to be activated, the control unit 130 commands the display unit 150 to display an interactive window 310 corresponding to the first operating system, as illustrated in FIG. 3B.

Thereafter, when a user inputs an activation signal (S450), the control unit 130 sequentially activates the deactivated operating systems (S470). It is understood that the control 130 is not limited to sequentially activating the deactivated operating systems, and may instead activate the deactivated operating systems out of sequence.

If a user inputs an activation signal after the virtual machine creating unit 140 has created each of the virtual machines corresponding to, for example, the first and second operating systems, and the interactive window 310 corresponding to the first operating system is displayed (as illustrated in FIG. 3B), the control unit 130 deactivates the activated operating system (the first operating system in this example) and activates the deactivated operating system (the second operating system in this example). As a result, the display unit 150 displays an interactive window 320 corresponding to the second operating system, as illustrated in FIG. 3C. The control unit 130 then repeats the above-described operations whenever the user inputs another input signal, as illustrated in FIG. 4.

The operating system switching device and method thereof according to aspects of the present invention thus provides a plurality of virtual machines corresponding to a plurality of operating systems, where the plurality of virtual machines function independently from the host operating system.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An operating system switching device comprising:
an input unit which receives a selection signal corresponding to one or more operating systems among a plurality of operating systems; and
a virtual machine creating unit which creates one virtual machine corresponding to each of the selected operating systems to boot the selected operating systems,
wherein the virtual machine creating unit comprises firmware.

2. The operating system switching device of claim 1, wherein the firmware comprises an extensible firmware interface.

3. The operating system switching device of claim 1, wherein the virtual machines are created and function independently from each other.

4. The operating system switching device of claim 1, wherein the input unit further receives an activation signal which activates a corresponding operating system among the selected operating systems.

5. The operating system switching device of claim 4, further comprising a display unit which displays an interactive window to operate the activated operating system.

6. The operating system switching device of claim 5, wherein the interactive window is displayed during checking of peripheral devices before the operating system switching device is booted by using a predetermined one of the operating systems.

7. The operating system switching device of claim 6, wherein the checking of the peripheral devices before the operating system switching device is booted comprises a Power-On Self Test (POST) step.

8. The operating system switching device of claim 1, further comprising a storage unit which stores the plurality of operating systems.

9. An operating system switching method comprising:
selecting one or more operating systems among a plurality of operating systems; and
creating one or more virtual machines which correspond to the selected operating systems and boot the selected operating systems,
wherein the virtual machine is created by a virtual machine creating unit comprising firmware.

10. The operating system switching, method of claim 9, wherein the firmware comprises an extensible firmware interface.

11. The operating system switching method of claim 9, wherein the virtual machines are created and operate independently from each other.

12. The operating system switching method of claim 9, further comprising
receiving an activation signal which activates a predetermined operating system among the selected operating systems.

13. The operating system switching method of claim 11, further comprising
displaying an interactive window to operate the activated operating system.

14. The operating system switching method of claim 13, wherein the displaying of the interactive window further comprises displaying the interactive window during checking of peripheral devices before the operating system switching device is booted by using a predetermined one of the operating systems.

15. The operating system switching method of claim 14, wherein the checking of the peripheral devices before the operating system switching device is booted comprises a Power-On Self Test (POST) step.

16. An operating system switching device, comprising:
a virtual machine creating unit which creates virtual machines corresponding to one or more operating systems selected out of a plurality of operating systems and boots the selected operating systems,
wherein the virtual machine creating unit comprises firmware.

17. The operating system switching device of claim 16, further comprising an input unit which receives a selection signal inputted from a user to select the one or more operating systems.

18. The operating system switching device of claim 16, wherein the firmware comprises an extensible firmware interface.

19. An operating system switching device, comprising:
an input unit which receives a selection signal corresponding to one or more selected operating systems selected by a user from a plurality of operating systems; and
a virtual machine creating unit which creates virtual machines corresponding to the one or more selected operating systems and boots the selected one or more operating systems, wherein the virtual machine creating unit functions independently from the one or more operating systems.

20. The operating system switching device of claim 19, wherein the virtual machines are created and function independently from each other.

21. The operating system switching device of claim 20, wherein the input unit further receives an activation signal which activates a corresponding operating system among the selected operating systems.

22. The operating system switching device of claim 21, further comprising a display unit which displays an interactive window to operate the activated operating system.

23. The operating system switching device of claim 22, wherein the interactive window is displayed during checking of peripheral devices before the operating system switching device is booted by using a predetermined one of the operating systems.

24. The operating system switching device of claim 23, wherein checking of the peripheral devices before the operating system switching device is booted comprises a Power-On Self Test (POST) step.

25. The operating system switching device of claim 19, further comprising a storage unit which stores the plurality of operating systems.
